(19) United States
(12) Patent Application Publication
(10) Pub. No.: US 2002/0010650 A1
(43) Pub. Date: Jan. 24, 2002

(54) Data carrier-based electronic goods/services procurement/purchasing system

(76) Inventors: S.K.H. Eberhard Herzog von Wuerttemberg, Stuttgart (DE); Christian Albertshofer, Meiningen (DE); Siegfried Praegner, Putzbrunn (DE)

Correspondence Address: SMITH-HILL AND BEDELL, 12670 N W BARNES ROAD, SUITE 104, PORTLAND, OR, 97229

(21) Appl. No.: 09/902,851

(22) Filed: Jul. 10, 2001

(30) Foreign Application Priority Data
Jul. 12, 2000 (EP) 00115148.9

(51) Int. Cl. G06F 17/60

(52) U.S. Cl. 705/26

(57) ABSTRACT

A data carrier-based electronic goods/services procurement/purchasing system in which transactions with multiple goods and services providers (container partners) are handled by means of data carrier cards (2) via a system computer (12, 24), wherein in the system at least one memory location (6) for user-individual data is provided on the data carrier card (2); a memory location (8) for user-individual container data is provided in the system, i.e. for data suitable for linking the user to multiple providers (container partners) in the purchasing system; at least one linking logic (25), arranged on the card (2) or at some other system location (24), which on user access to the system and/or when a user transaction with a container partner has already been handled, automatically prompts at least one further action by the same or other container partner depending on the user-individual data and/or transaction data of the user, the further action being communicated to the user via a data output (16) incorporated in the system; the linking logic basing decisions on the memorized user-individual data (6) and/or on the memorized user-individual container data (8) and on the access features predefined at the container partner end.

### BACKGROUND OF THE INVENTION

Field of the Invention

The invention relates to a data carrier-based electronic goods/services procurement/purchasing system. Systems have since become known which on the basis of a chip card enable the user thereof to make transactions with multiple contract partners, simply termed container partners in the following, whereby data individual to the user is already automatically involved in a transaction in part. The drawback for the user when involved in a more complicated transaction, for example in travel booking, is that he needs to seek out multiple, different goods or services associated therewith, such as e.g. rental car and travel insurances, himself.

### SUMMARY OF THE INVENTION

It is thus the objective of the present invention to develop a chip card system which enables the user to do business involving multiple transactions with minimum delay and effort and which enables the container partners to enhance their presence with the user and to direct their offers to the user of the system more targeted and effectively.

This objective is achieved by a system having the features as set forth in claim 1. Advantageous further embodiments of the invention are the subject matter of the sub-claims.

The card-assisted purchasing system in accordance with the invention comprises an electronic terminal system enabling the user to enter a virtual digital marketplace. The entry card to the system is formed by a data carrier card, more particularly a chip card, containing data individual to the user. “Terminal”, in this sense is understood in the following to cover all end appliances capable of making a connection to the Internet or some other network in making use of a chip card, i.e. also including home PCs and mobile telephones suitably equipped.

The system comprises multiple components, the interaction of which will be detailed in the following: a system/card operator which manages the system; container partners having concluded a contract with the system operator for extending target offers to selected users of the system;users having a chip card for using the system; a data carrier, more particularly, chip card including personal data of the user; memory locations in the system including personal data of the user and transaction data, i.e. data as to transactions enacted by the user in the system previously; at least one linking logic for checking whether a system user is to be made an offer on the basis of comparing predefined features of the container partner with the personal data and/or user-individual container data and/or transaction data of the user.

The key to the whole system is the data carrier card. In its simplest form this may incorporate an ID code enabling the system to identify the user, it being via this ID code that the system, i.e. the linking logic has access to the user-individual data. Preferably the data carrier card is a chip card and contains all necessary user-individual data such as sociodemographic data including e.g. sex, age, occupation, hobbies, marital status, previous transactions, etc. In addition the chip card or system contains multiple user-individual memory locations, in short, container data areas, in which the various providers can post their data, enabling the container partners to make an offer to the user on entering the virtual market place which is tailored to his requirement or which is likely to be of interest to him as indicated by his individual data. Checking this is done by a linking logic provided in the system, more particularly in the terminal.

It is via the linking logic of the system that access of the user to the system and/or the transaction of the user is linked to further actions of the same or some other container partner. These actions are freely definable via the linking logic or involving a data area of the container partner as used by the linking logic, e.g. thematically or can be considered as being goods/services supplementary to the goods/services of a transaction. Thus, the linking logic preferably contains a matrix in which a container partner has defined links to other goods/services or features of user-individual data and which serve as the basis for producing the links. The corresponding link data is held preferably in the container data areas of the access terminal, although they could be saved also on the chip card in the container data areas or on a host computer or computer of a container partner.

Each container data area of the card is defined and written preferably by the corresponding container partner. It may comprise all actions having taken place between user and container partner, thus for example also the offers made by the container partner to the user as well as user-individual (sociodemographic) data, transaction data and data as may be used by the linking logic for a linking decision.

When a user implements a transaction, for example, with a party service, a link to a beverage service may be generated automatically which is likewise memorized as the container partner on the chip card of the user.

As already indicated above, this linking logic enables container partners to target advertising and offers which are much more likely to be accepted and successful than any other since the customer is known by his user-individual data and who may have already made one or more transactions and whose purchasing profile is already known to a certain extent. The container partner is thus able to define and approach target groups with a high probability of being successful due to these predefined linking features. An offer made to such a select group of people is marketing-oriented and targeted in now achieving a very much higher probability of being successful than hitherto possible in the marketplace.

Preferably the system contains a priority algorithm which, when multiple links are generated following a user transaction, produces a priority between the container partners which ensures that a certain appropriate sequence is kept to in the offers made by the various container partners to the user, the priority algorithm controlling the timing sequence thereof in accordance with logical considerations and to avoid the user feeling pestered by the offer sequence.

The providers assigned the container data may be displayed as buttons for user access, i.e. on entering the virtual marketplace. These providers may be, for example, insurance companies, rental car agencies, banks, etc. Thus, when the user gains access to the system, these undertakings or their offers appear on his opening display, considerably enhancing their presence with the final consumer. Container partners are the undertakings having concluded a contract regulating use of the system and defining fees with the card or system operator.

If a container partner is still to be loaded on the chip card of the user, although the user is to be considered as the target group in accordance with the predefined memorized linking features, the user can be asked if he wishes to become a customer of the container partner. If the user answers in the affirmative, user-individual container data is loaded on the chip card of the user. When he then in the future accesses the system the user receives targeted offers of the container partner loaded on the chip card, whereby the offering action and any resulting actions can be held or noted in the container data area of the chip card.

Optionally the system may also contain a search routine to assist the user in seeking specific goods/services in being referenced to the page of a corresponding container partner where he in turn is asked whether he wishes to become a customer so that he automatically receives further offers from the container partner.

The advantage of the system lies further in the fact that in making or obtaining an offer, e.g. when opening the corresponding page, the user-specific data of the user can be simultaneously used by the container partner to tailor the offer of the provider to the requirements of the user.

Once an offer has been accepted on the part of the user, for instance a travel booking, the container data set of the corresponding container partner is automatically updated and, where necessary, the transaction data written into a user-individual memory, arranged more particularly on the chip card. In general the conclusion of any transaction results in a transaction data set being generated which is examined by the linking logic of the system in taking into account all container data sets provided on the chip card for the existence of features which could prompt an action of a further container partner. The transaction data set contains preferably personal data of the user as well as the transaction data and is stored on the chip card.

At the same time, an accounting entry can be generated which automatically debits an account, handled for example by another container partner, whereby successful debiting of the account can be informed to the container partner of the transaction (travel agency) by a container data set, upon which in turn the travel agency can instigate all necessary actions.

It is, of course, just as possible with every successful or confirmed transaction to credit the account of the user in accordance with a discount or bonus system by predefined container partners or even by the system operator himself, thus making it attractive for the user to making use of the offers made by the container partners of his chip card.

The system includes a user surface with various pages which guide the user through the system of the virtual market place. This system may be based on the usual web standard and HTML as well as Java used for the page formats as well as the same transmission mode as the Internet. It is also possible in principle to use the Internet as the portal for the system, in which case an encryption system (firewall) is to be provided to safeguard the system against hostile intervention. However, any other kind of netware may also be used.

The network comprises preferably a plurality of terminals, e.g. home PCs including both a chip card reader and input/output unit. Either a keyboard, a mouse or a touch-screen display may serve as the input unit, whereas a conventional monitor or touch-screen display, loudspeaker or printer may serve as the output unit. It is, of course, just as possible to combine various input and output units with each other. In addition each terminal includes a data interface, e.g. a modem or ISDN connection for remote data communication, e.g. via Internet and/or Intranet. Due to the fact that each home PC can be used as a terminal on being installed with a chip card reader/writer, acceptance of the system can be substantially enhanced.

Use of the terminals can be controlled centrally or decentrally.

Where central terminal management is provided, a connection is made to the host computer at least for the time needed to make the connection or log-on after insertion of a chip card, via which the identity and access authority of the card owner can be checked, where necessary, in making use of a password system. Furthermore, container partner page data can be transferred, where necessary, via the host computer to the terminal.

Where control is decentralized, each terminal has an identification system enabling the user and, where necessary, passwords to be identified. Where on-line accounting is provided, a connection to the central control must always be made for checking the account data and to receive corresponding confirmation signals. Furthermore, in decentralized control of the terminals, also, a connection must be made periodically, e.g. via modem to the central system to update the terminals, e.g. to communicate new pages from new container partners or to delete pages from container partners no longer on contract with the card operator. Where necessary, the terminal contains its own memory on which the container partner pages are stored; although it may also merely contain the hardware needed for Internet access. The hardware is preferably configured so that access is possible only to the system<<s own central search system as well as to the pages of the container partners in the system or to the container partners memorized on the chip card.

The account of the user is preferably held likewise by a container partner who is under contract to the card operator, such a container partner being a bank of savings institute. Payment can be made by the user online from the account with confirmation of the transaction, the card owner in this case receiving a voucher which may be printed out or also written on the card.

When the container partner of the card operator is a hotel chain, the hotel chain has hardware facilities permitting use of the chip card for these facilities, for example, door locks.

When, for example, the customer has booked a room in a hotel via a terminal, a booking data set is memorized in the container memory location of the container partner containing individual data of the hotel booked, the period booked and the room number already. The door lock systems of the hotel contains electronic locks capable of reading the data set on the chip card and to open the lock when the booking data set tallies.

Furthermore, data output units are preferably provided at the container partners, enabling the user to obtain a printout and/or display of at least the data relating to the container partner concerned such as, for example, reservation data or the like.

The contact between the host computer and the terminals is made preferably via Internet in which case no special data transfer paths need to be provided. Communicating system security data may also be made, however, directly between host computer and terminal.

Telecom companies may also function as container partners, in which case the terminals should also then include the hardware necessary for making use of telecom services.

### BRIEF DESCRIPTION OF THE DRAWINGS

The invention will now be detailed with reference to the diagrammatic drawing in which:

FIG. 1 is a view of a chip card for using the system,

FIG. 2 is a general diagrammatic representation of the virtual market place system, and

FIG. 3 is a more detailed diagrammatic representation of a terminal in the marketplace system as shown in FIG. 1.

### DETAILED DESCRIPTION

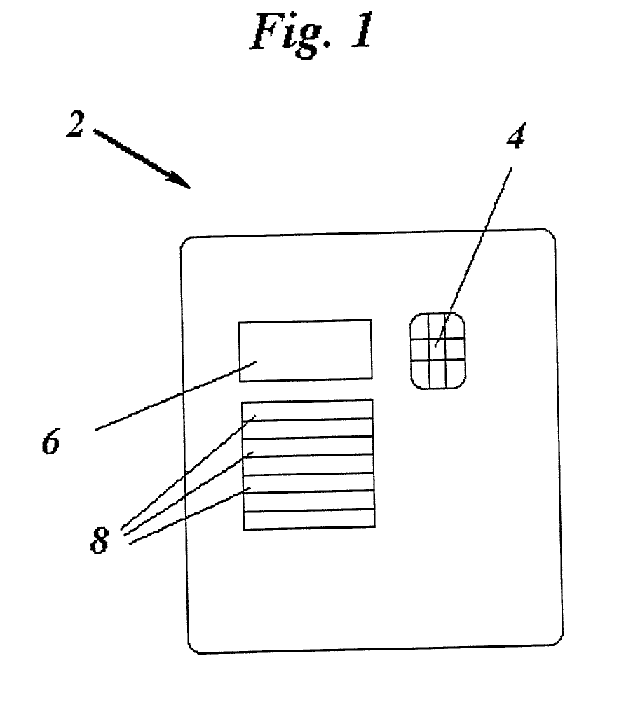

Referring now to FIG. 1 there is illustrated a chip card 2 for use in a virtual purchasing system in accordance with the invention. The chip card in conventional check card format comprises a logic/memory chip including readout contacts 4 and a system data area (not shown). The chip comprises a user data memory 6, indicated merely diagrammatically, and multiple container data memories 8, one such memory location 8 being provided for each container partner of the customer.

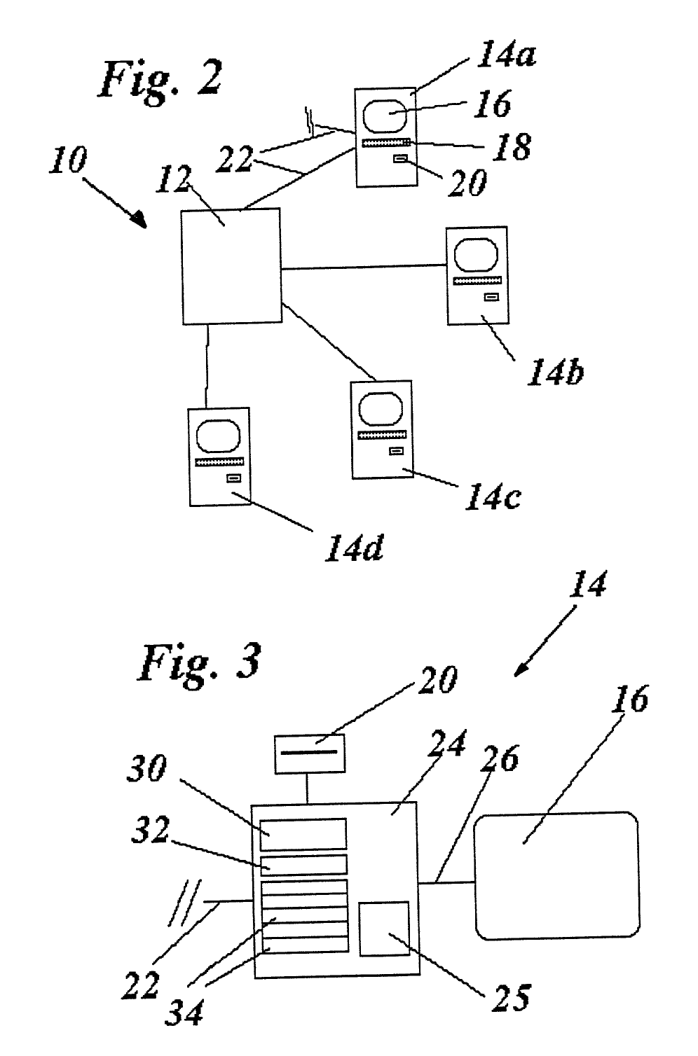

Referring now to FIG. 2 there is illustrated a purchasing system 10 consisting of a host computer 12 and a series of terminals 14a to 14d, each of which is provided with a touch-screen display 16, input keyboard 18 and chip card reader 20. Each terminal 14 is connected to the host computer 12 at least temporarily via a data line 22. Remote data transfer is possible via a modem or via any other suitable interface. Via the data line 22 the terminals 14 can also be connected to the Internet, for example also directly to the container partners without this necessitating a connection via the host computer 12.

Referring now to FIG. 3 there is illustrated the configuration of a terminal 14 in more detail. The terminal 14 includes a computer 24 which is connected to the chip card reader 20 as well as via an input/output line 26 to a touch-screen display 16. Optionally, further peripheral items such as cursor controls or keyboards may be provided. The computer 24 contains a system memory location 30, a card data area 32 in which user data and transaction data of the user can be stored, as well as container data areas 34 holding the access data or pages of all container partners on contract to the card operator. The computer 24 contains in addition the linking logic 25 for controlling container partner actions in conjunction with user access to the system or a transaction of the user.

In addition, the computer 24 can also be coupled via the data line 22 to the host computer 12.

The system data area 30 of the computer 24 contains the communication platform for the exchange of data between card and computer, for data input/output to/from the touch-screen display 16 as well as for the communication between terminals 14 and host computer 12 or between terminals 14 and the computers of the individual container partners.

The functioning of the system will now be described. After the user has inserted his chip card in the chip card reader 20, the computer 24 loads data from the user data memory 6 and the container data memory locations 8 on the chip card into the card data area 32 of the terminal 14. The user then receives a welcome page display, the configuration of which is controlled by a linking logic, each container partner of the system namely defining, at the outset, features intended to result in linking a customer to the container partner. The linking logic checks whether the features defined by the container partner tally with the user data. These features may including not only personal data of the customer such as age, sex, hobbies, etc. but also transaction data from previous purchasing actions of the customer in the system as held in the user data memory 6 or in the container data memories 8 of the chip card 2. Once the linking logic in computer 24 confirms that the data tally, the user is asked—if not already a customer of the container partner—whether he wishes to become a customer. In the affirmative, the data of the container partner is loaded from the container data area 34 of the computer 24 into the container data memory 8 of the chip card 2. If the user is already a customer of the container partner, the latter can post an offer to the user on the starting page of the system for access by the customer. All future transactions with this container partner of the user are stored in the container data memory 8 of the chip card, whereby interactive access of the customer is preferably menu-guided via the touch-screen display 16.

If the user is already a customer of the container partner, an offer corresponding to his buying profile and sociodemographic data is sent to him as long as he corresponds to the features defined by the container partner for the offer which, where necessary in making use of data from the container data area 8 of the card 2, is researched in the linking logic 25 of the computer 24 or of the host computer 12. The user thus receives on his opening display a number of offers of the container partners loaded on his card, all tailored to his particular requirements.

If the user concludes a transaction with a container partner, the linking logic checks in turn whether this transaction belongs to a predefined access element of the same or some other container partner. If so, the user then automatically receives an offer from the other container partner or a further offer from the same container partner on conclusion of the transaction.

When a decentralized terminal is operated offline, the pages or access data of the container partners are held in the container memory locations 34 of the computer 24 and displayed after each transaction or access action of the user via the touch-screen display 16. Preferably, however, a keyboard 18 is also provided for alphanumeric input.

When the terminal 14 is operated online, the container data memory location 34 of the terminal can be reduced since in this case the terminal has the sole task of controlling peripherals such as chip card reader, touch-screen, linking logic and keyboard whilst the information display is handled by net pages. In this case the user has direct access to the web pages held by the container partners. Thus, in the user memory location 32 of the computer 24 of the terminal 14 only the web addresses of the container partners are saved by the card, page addressing of the individual container partners already being done in taking into account the user-individual data from the chip card saved in the card data area 32 of the terminal. This is achievable by an ID number already being included in the requirement for a web page for the user, so that the web page of the container partner can be displayed in taking into account the personal data, or the personal data are inserted by the computer 24 into the empty web page as received from the container partner. Each and every transaction and access action of the user is saved in the card data area 32 of the terminal 14 as well as, where necessary, in the individual user data area 6 or container data area 8 of the chip card 2 and used as the starting point for further menu control, i.e. in displaying links (references), etc.

All terminals, operating both online and offline, are updated periodically by the host computer 12 (FIG. 1) of the system in keeping the software up-to-date as well as loading new container partners into the system and deleting those whose contract has expired.

As a sophisticated further development for simple application in e-business the complete system is exceptionally user-friendly.

It is practically irrelevant for the invention whether the memory or computing locations are provided on the chip card 2, terminal 14 or host computer 12; it is, however, of advantage when a memory 6 for user-individual data as well as for user-individual container data 8 is provided on the chip card 2 to permit practically stand-alone application of the terminals.

1. A data carrier-based electronic goods/services procurement/purchasing system in which transactions with multiple goods and services providers (container partners) are handled by means of data carrier cards via a system computer, wherein in said system
at least one memory location for user-individual data is provided on said data carrier card,
a memory location for user-individual container data is provided in said system, i.e. for data suitable for linking the user to multiple container partners in said purchasing system,
at least one linking logic, arranged on said card or at some other system location, which on user access to said system and/or when a user transaction with a container partner has already been handled, automatically prompts at least one further action by the same or other container partner depending on the user-individual data and/or transaction data of the user, said further action being communicated to the user via a data output incorporated in said system, said linking logic basing decisions on said memorized user-individual data and/or on said memorized user-individual container data and on said access features predefined at the container partner end.

2. The system as set forth in claim 1 wherein said data carrier card is formed by a chip card comprising memory locations for said user-individual container data.

3. The system as set forth in claim 1 wherein said linking logic comprises a matrix in which the presence of features predefined by a container partner, or a combination of features of user-individual data and/or container data of the transaction partner of said user, defines the basis for starting a further action by said container partner.

4. The system as set forth in claim 2 wherein said linking logic comprises a matrix in which the presence of features predefined by a container partner, or a combination of features of user-individual data and/or container data of the transaction partner of said user, defines the basis for starting a further action by said container partner.

5. The system as set forth in claim 1 comprising a priority algorithm which defines the sequence of several further actions by container partners in accordance with a memorized or computed access sequence.

6. The system as set forth in claim 1 wherein said further action is the automatic display of an offer page, e.g. Internet page, and in which a central control is provided to utilize user-individual data and/or user-individual container data and/or data from another transaction in page boxes.

7. The system as set forth in claim 1 wherein a user account and/or electronic exchange is installed in said system which is automatically debited by the user on confirmation of a transaction.

8. The system as set forth in claim 7 wherein a confirmation data set is sent to said transaction partner of the user by the account operator, e.g. a container partner, upon which the requested transaction is started.

9. The system as set forth in claim 7 wherein a central control of said access system prompts, as a function of memorized discount or bonus data, crediting of said account by said container partners and/or system operators on confirmed conclusion of a transaction.

10. The system as set forth in claim 8 wherein a central control of said access system prompts, as a function of memorized discount or bonus data, crediting of said account by said container partners and/or system operators on confirmed conclusion of a transaction.

11. The system as set forth in claim 1 wherein the data of a completed transaction are written into said container data memory location on said data carrier card and/or into a system memory or container partner memory.

12. The system as set forth in claim 1 wherein data relating or subsequent to a transaction is saved on said data carrier card or in a system memory or container partner memory and wherein terminals are provided for displaying said data and, where necessary, the actions needed in conjunction with said transaction.

13. The system as set forth in claim 12 wherein hardware components, such as e.g. electric door locks are provided including a chip card reader and a decentralized control for operating as a function of said transaction data.
